(19) United States
(12) Patent Application Publication
(10) Pub. No.: US 2014/0150914 A1
(43) Pub. Date: Jun. 5, 2014

(54) AIR GUIDING DEVICE FOR A BLOWER HOUSING

(71) Applicant: MAGNA Electronics Europe GmbH & Co. KG, Sailauf (DE)

(72) Inventors: Brian HAVEL, Aschaffenburg (DE); Paul MCLENNAN, London (CA)

(73) Assignee: MAGNA Electronics Europe GmbH & Co., KG, Sailauf (DE)

(21) Appl. No.: 14/093,205

(22) Filed: Nov. 29, 2013

(30) Foreign Application Priority Data
Dec. 4, 2012 (DE) 10 2012 222 258.8

(51) Int. Cl. B60K 11/06

(52) U.S. Cl. CPC B60K 11/06
USPC 138/109

(57) ABSTRACT

Air guide for a fan cowling of a motor vehicle, the fan cowling being arranged downstream of a heat exchanger in a direction of airflow. The air guide includes an air guide body having a plurality of surfaces and an air passage opening arranged between adjacent surfaces of the air guide body, a guide surface which corresponds to the opening and configured to act on airflow through the air passage opening; and an end region which extends from the guide surface and which is spaced from and extends in a plane which is substantially parallel to a plane of the surface of the air guide body. The guide surface begins at a first edge of the air passage opening and the end region ends at the opposite edge of the opening, and the end region does not overlap with an adjacent surface that continues at the opposite edge of the air passage opening.

### CROSS-REFERENCE TO RELATED APPLICATIONS

The present application claims priority 35 U.S.C. §119 to German Patent Publication No. DE 10 2012 222 258.8 (filed on Dec. 4, 2012), which is hereby incorporated by reference in its entirety.

### TECHNICAL FIELD

Embodiments relate to an air guide in a fan cowling of a motor vehicle, wherein the fan cowling is arranged downstream of a heat exchanger in the direction of the airflow and the air guide includes a tabular element, with a substantially slot-shaped opening in the tabular element. A guide surface is allocated to the slot and acts on the air flowing from the interior of the fan cowling to the outside through the opening, and an edge of the opening transforms into the guide surface via a radius. At the end region facing away from the tabular element, the guide surface has a portion which runs parallel to the tabular element. The end region of the guide surface ends at the opposite edge of the opening, and wherein the elements of the air guide, the openings, the guide surfaces, the end regions are arranged in a separate component which may be connected to the fan cowling.

### BACKGROUND

In motor vehicles with internal combustion engines, the waste heat produced by the internal combustion engine may be emitted to the surrounding atmosphere by a heat exchanger or radiator. In vehicles with front-mounted engines, for example, the heat exchanger is installed at the front in the direction of travel and is supplied with fresh air via radiator grille openings. The ambient air is supplied to the heat exchanger by the travel wind. In addition a fan is arranged downstream of the heat exchanger and generates an airflow through the heat exchanger. This is necessary in particular at low travel speed since the fresh air supplied at low speed causes only a correspondingly low heat dissipation.

In the radiator devices described, the fan is associated with the heat exchanger by means of a casing, or fan cowling, such that the air conducted through the heat exchanger is supplied to the fan. The fan cowling, made from sheet metal or as a plastic part, acts as a hopper and holds one or more fans.

At low travel speeds, the air throughput is mainly generated by the fan. As the travel speed increases, the proportion caused by the travel wind increases. To allow the passage of the proportion of fresh air, which increases with the speed, air passage openings may be provided in the casing in the area outside the fan. These air passage openings, designed for example as slots, however also constitute a bypass for the fan flow, such that a particular proportion of the air conveyed by the fan is not drawn in through the heat exchanger but through these air passage openings.

German Patent Publication No. DE 10 2004 018 036 A1 discloses guide plates in a fan cowling, wherein the angular arrangement of the guide plates and hence the deflection direction of the air runs at an angle to the direction of the inflowing air. A further design described in this publication provides guide vanes of curved form.

French Patent Publication No. FR 2 816 360 A1 discloses an arrangement of fan, fan cowling and heat exchanger in which the fan and cowling sit in front of the heat exchanger in the direction of travel. The cooling air is thus conveyed via the fan opening into the fan cowling and then through the heat exchanger. At low speeds, the driven fan draws the air in the direction of the heat exchanger. To increase or improve the air throughput, especially at high travel speeds, air passage slots are provided in the cowling which run in a curved shape concentric to the fan axis. Their arrangement is such that they offer little resistance to the air flowing in at travel speed. The air passage slots have overlapping portions running parallel to each other. The arrangement, in which a slot lies in a tabular surface both on the inside and outside of the fan cowling, is substantially symmetrical so that the flow resistance is the same in both directions.

German Patent Publication No. DE 34 46 950 C1 discloses ram air openings in a fan cowling outside the fan circle. Ram air valves are allocated thereto.

German Patent Publication No. DE 88 06 976 U1 discloses additional air openings with non-return valves are provided. These allow the air to pass through in one direction. A blockage occurs in the other direction. Another known solution provides a form of non-return valves by means of rubber flaps which allow the air to flow through the openings into the cowling at high speeds.

German Patent Publication No. DE 11 2005 002 765 T5 discloses a fan cowling with a fan, wherein an outlet gap is provided between the fan and the fan cowling for the centrifugal flow generated by the fan.

WO 2008 074 307 A1 discloses a gap in the transition region described between the cowling and the fan for the return of fan air.

U.S. Pat. No. 1,586,534 A discloses air inlet openings in a controllable fan grille, wherein the air openings are arranged in front of the heat exchanger.

### SUMMARY

Embodiments relate to an air guide in a fan cowling which is enhanced in relation to the known solutions.

In accordance with embodiments, an air guide for a fan cowling of a motor vehicle, the fan cowling being arranged downstream of a heat exchanger in a direction of airflow, the air guide including at least one of the following: a tabular element having a substantially slot-shaped opening therein; a guide surface allocated to the slot and configured to act on the air flowing from an interior of the fan cowling to the outside through the opening, wherein an edge of the opening transforms into the guide surface via a radius, the guide surface having, at the end region facing away from the tabular element, a portion which runs parallel to the tabular element, wherein the end region of the guide surface ends at the opposite edge of the opening, and wherein the elements of the air guide, the openings, the guide surfaces, the end regions are arranged in a separate component which may be connected to the fan cowling.

In accordance with embodiments, an air guide for a fan cowling of a motor vehicle may include at least one of the following: an air guide body having a plurality of surfaces and an air passage opening arranged between adjacent surfaces of the air guide body; a guide surface which corresponds to the opening and configured to act on an airflow through the air passage opening; and an end region which extends from the guide surface and which is spaced from and extends in a plane which is substantially parallel to a plane of the surface of the air guide body, wherein the guide surface begins at a first edge of the air passage opening and the end region ends at the opposite edge of the opening, and the end region does not overlap with an adjacent surface that continues at the opposite edge of the air passage opening.

In accordance with embodiments, an air guide for a motor vehicle may include at least one of the following: a plurality of air guide surfaces; an air passage opening arranged between adjacent air guide surfaces; a guide surface which extends from an air guide surface and corresponds to the air passage opening; and an end region which extends from the guide surface in a plane which is substantially parallel to a plane of the surface of the air guide body, wherein the guide surface begins at a first edge of the air passage opening and the end region ends at the opposite edge of the opening, and the end region does not overlap with an adjacent surface that continues at the opposite edge of the air passage opening

In accordance with embodiments, a motor vehicle may include at least one of the following: an air guide having: a plurality of air guide surfaces; an air passage opening arranged between adjacent air guide surfaces; a guide surface which extends from an air guide surface and corresponds to the air passage opening; and an end region which extends from the guide surface in a plane which is substantially parallel to a plane of the surface of the air guide body, wherein the guide surface begins at a first edge of the air passage opening and the end region ends at the opposite edge of the opening; and the end region does not overlap with an adjacent surface that continues at the opposite edge of the air passage opening.

In accordance with embodiments, the guide surface adjacent to the edge of the slot follows the airflow from the interior of the fan cowling (the interior of the fan cowling is the interior space enclosed by the heat exchanger and fan cowling) to the outside. The guide surface is formed running correspondingly from the surface to the outside.

In accordance with embodiments, several openings or opening slots running parallel to each other are arranged in the tabular element.

In accordance with embodiments, the tabular element with the air passage opening or openings is a separate component which may be inserted in a provided receiver region of the fan cowling. In particular, an adjustability of the air guide or guide element may be provided. If the air guide element forms a tabular element in the form of a round disc, the air guide may be adjusted by rotating the disc. Thus, the same air guide elements may be used at several points on a fan cowling, the air guidance to be provided, the direction, is adjusted by the rotary orientation of the air guide element. Thus different model variants may be equipped economically.

In accordance with embodiments, the component of the air guide has fixing elements for mounting to the fan cowling. In the embodiment of the air guide element as a disc, these are radial cutouts by means of which the disc may be inserted in a bayonet-type receiver in the fan cowling.

In accordance with embodiments, the air guide is configured to allow the air passage openings to be arranged directly in the surface of the fan cowling. In particular, in a fan cowling made of plastic in an injection moulding process, the vent slots in accordance with embodiments may easily be produced together with the guide surfaces.

In accordance with embodiments, an air guide element may be configured as a tabular element which has several air passage slots on a surface, a surface region, running in a V-shape or cross-section. An edge of the slot, following the proposed airflow, is angled downward under the surface. This angled region or portion forms the guide element with which the air is deflected in the proposed direction. The transition from tabular element to guide element is radiused. The end region of the guide element lying below the surface is formed as a portion running parallel to the surface. Preferably the portions as a whole are dimensioned such that, viewed in the vertical direction onto the tabular element, no visible opening is evident.

In accordance with embodiments, the air guide is configured to provide enhanced air throughflow, and guarantees that the air flowing out of the interior of the fan cowling meets a lower resistance than the air flowing from the outside into the fan cowling. This particularly advantageous since, at high travel speeds, the air conveyed by the travel wind through the heat exchanger into the fan cowling is not only output by the fan, so without additional venting an air build-up would result, which limits the heat dissipation of the heat exchanger. Secondly, the flow resistance for air from the outside into the interior of the fan cowling is significantly greater to prevent the fan from also drawing in air through the vent, which would then correspondingly reduce the air quantity drawn into the heat exchanger, and hence the heat dissipation.

### DRAWINGS

Embodiments will be illustrated by way of example in the drawings and explained in the description below.

FIG. 1 illustrates a fan cowling, in accordance with embodiments.

FIG. 2 illustrates section A-A of the guide surfaces and the end regions of the fan cowling of FIG. 1, in accordance with embodiments.

FIG. 3 illustrates section A-A of the guide surfaces and the end regions of the fan cowling of FIG. 1, in accordance with embodiments.

FIG. 4 illustrates section A-A of the guide surfaces and the end regions of the fan cowling of FIG. 1, in accordance with embodiments.

FIG. 5 illustrates section A-A of the guide surfaces and the end regions of the fan cowling of FIG. 1, in accordance with embodiments

### DESCRIPTION

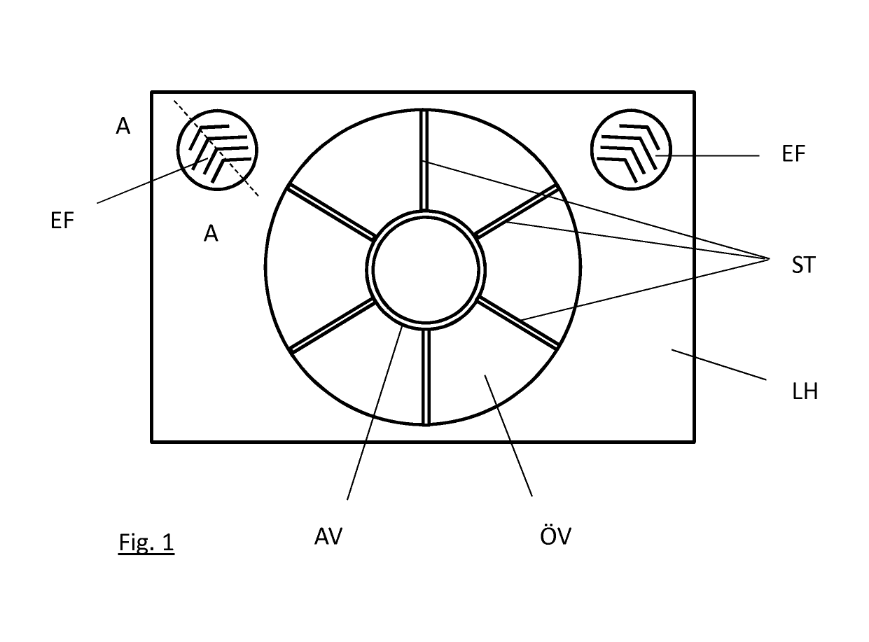

As illustrated in FIG. 1, a fan cowling LH is provided. The fan cowling LH may be arranged downstream of a heat exchanger of a motor vehicle. The depiction of the fan cowling LH is illustrated from an air supply direction, i.e., the direction in which the air penetrates the heat exchanger, and thus, enters the space (interior space) delimited by the fan cowling LH. The fan cowling LH on its peripheral region may be operatively connected to the heat exchanger via suitable a sealing device(s).

The fan cowling LH may have an opening ÖV for a fan. The motor of the fan may be arranged in an annular receiver AV which is supported centrally in the opening ÖV of the fan cowling LH via webs ST. In an upper region of the fan cowling LH, adjacent to the fan opening ÖV, a pair of vent regions EF may be arranged which have slotted openings Ö having a V-shape or cross-section which are configured to serve as air passages.

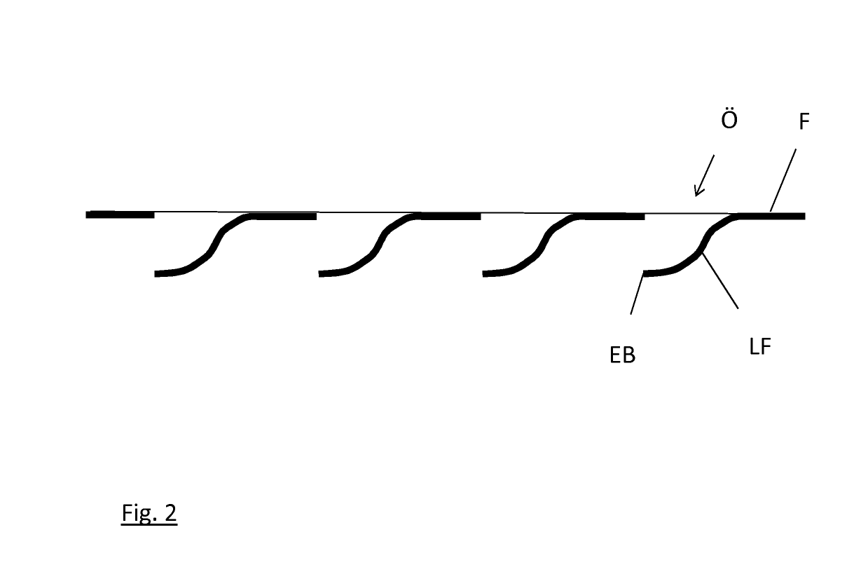

FIG. 2 illustrates section A-A as indicated by the dotted line in FIG. 1. A slotted air passage opening Ö is arranged between adjacent surfaces F of the fan cowling LH or a tabular element/air guide body inserted in the fan cowling LH. Extending downwardly from an edge of the opening Ö is a guide surface LF which transforms via a radius. Extending from the guide surface LF is an end region EB, which is spaced from and extends in a plane which is substantially parallel to the plane of the inner surface F of the fan cowling LH or the tabular element. The air passage opening Ö is configured to overlap the guide surface LF and the end region EB. For instance, the guide surface LF begins at the first edge of the air passage opening Ö and the end region EB ends at the opposite edge of the opening Ö. The end region EB, however, does not overlap with the adjacent surface F that continues at the opposite edge.

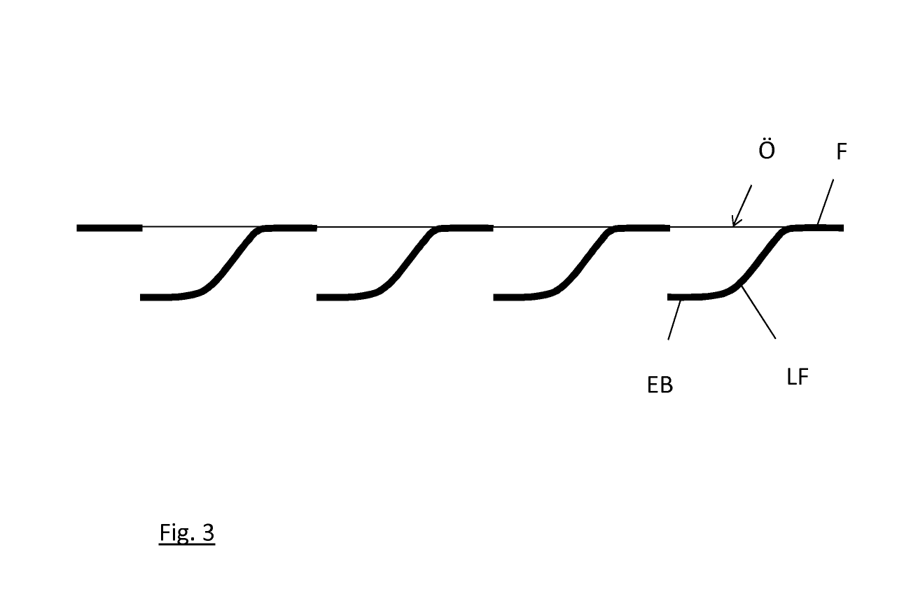

As illustrated in FIG. 3, an embodiment of the guide surfaces LF and the adjacent end regions EB in which the end region EB extends for a predefined portion in a plane which is parallel to plane of the inner surface of surface F. The air passage opening Ö is configured to overlap the guide surface LF and the end region EB. For instance, the guide surface LF begins at the first edge of the air passage opening Ö and the end region EB ends at the opposite edge of the opening Ö. The end region EB, however, does not overlap with the adjacent surface F that continues at the opposite edge.

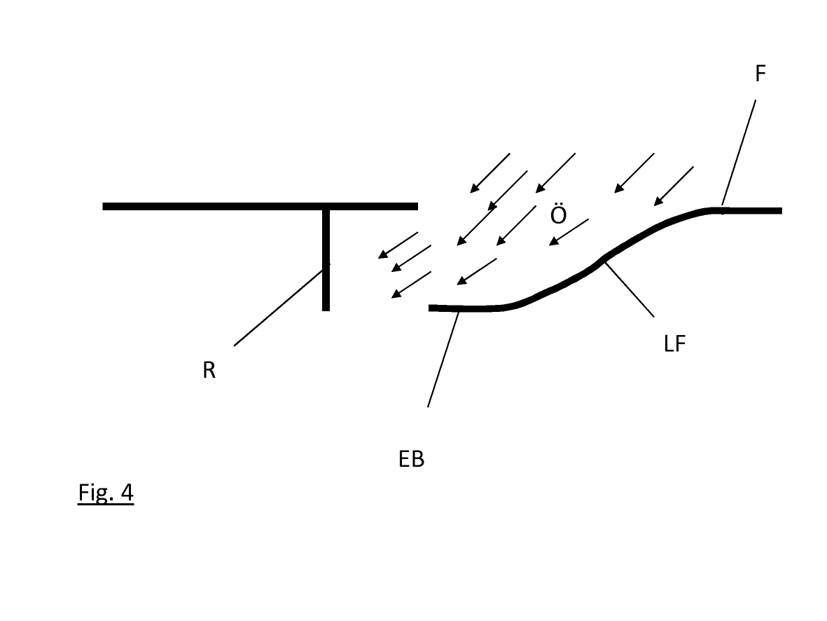

As illustrated in FIG. 4, another embodiment includes an opening Ö with adjacent guide surface LF and end region EB terminating the guide surface LF below the surface F. The arrows indicate the airflow. The airflow takes place from the interior of the fan cowling LH to the outside. The configuration of the opening Ö, the guide surface LF and the end region EB results in airflow out of the interior of the fan cowling LH with relatively low resistance. This advantageously prevents airflow build-up in the fan cowling LH which occurs at high travel speeds.

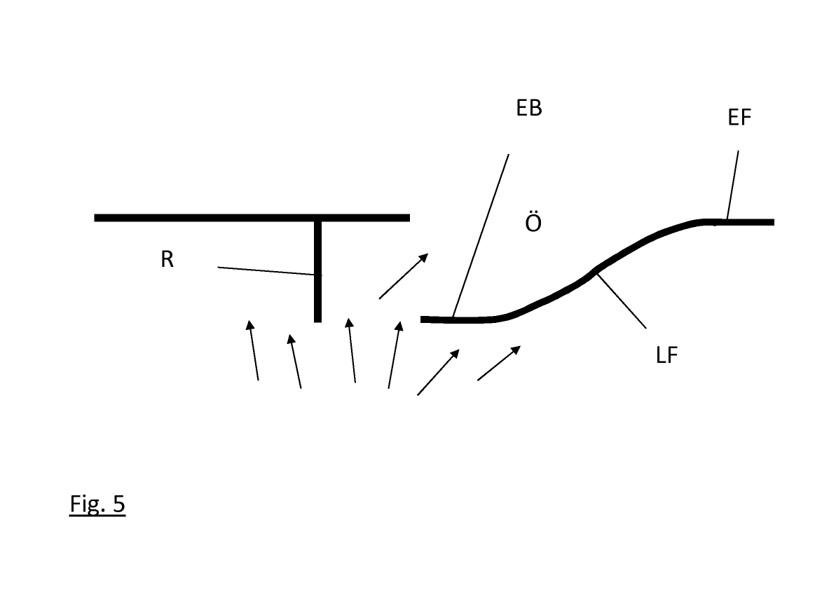

A rib R, oriented perpendicular to the surface F, is arranged spatially below the surface F which also guides the air flowing through the opening Ö. The rib R reduces the effective opening for airflow into the interior of the fan cowling LH. This airflow situation is illustrated with the arrows in FIG. 5. At low travel speed, the airflow through the heat exchanger results primarily or exclusively from the fan power. In accordance with embodiments, the effectively reduced opening prevents the air from simply passing through.

The airflow may be deflected by the guide surfaces, such as, for example, away from the fan. The slots or openings Ö are oriented accordingly in the surface F.

The term “coupled” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SIGNS

LH Fan cowling
ÖV Fan opening
AV Receiver for fan motor
ST Web
EF Vent surface
F Surface, tabular element
Ö Opening, air passage
LF Guide surface
EB End region
R Rib

What is claimed is:

1. Air guide for a fan cowling of a motor vehicle, the fan cowling being arranged downstream of a heat exchanger in a direction of airflow, the air guide comprising:
an air guide body having a plurality of surfaces and an air passage opening arranged between adjacent surfaces of the air guide body;
a guide surface which corresponds to the opening and configured to act on airflow through the air passage opening; and
an end region which extends from the guide surface and which is spaced from and extends in a plane which is substantially parallel to a plane of the surface of the air guide body,
wherein:
the guide surface begins at a first edge of the air passage opening and the end region ends at the opposite edge of the opening; and
the end region does not overlap with an adjacent surface that continues at the opposite edge of the air passage opening.

2. The air guide of claim 1, wherein the air passage opening has a V-shaped cross-section.

3. The air guide of claim 1, wherein the guide surface extends downwardly from a corresponding surface of the air guide body.

4. The air guide of claim 1, wherein the air passage opening is configured to overlap the guide surface and the end region.

5. The air guide of claim 1, wherein the air passage opening, the guide surface and the end region are arranged in a separate component configured for connection to the fan cowling.

6. Air guide for a motor vehicle, the air guide comprising:
a plurality of air guide surfaces;
an air passage opening arranged between adjacent air guide surfaces;
a guide surface which extends from an air guide surface and corresponds to the air passage opening; and
an end region which extends from the guide surface in a plane which is substantially parallel to a plane of the surface of the air guide body,
wherein:
the guide surface begins at a first edge of the air passage opening and the end region ends at the opposite edge of the opening; and
the end region does not overlap with an adjacent surface that continues at the opposite edge of the air passage opening.

7. The air guide of claim 6, wherein the air passage opening has a V-shaped cross-section.

8. The air guide of claim 6, wherein the guide surface extends downwardly from a corresponding surface of the air guide body.

9. The air guide of claim 6, wherein the air passage opening is configured to overlap the guide surface and the end region.

10. The air guide of claim 6, wherein the air passage opening, the guide surface and the end region are arranged in a separate component configured for connection to the fan cowling.

11. A motor vehicle, comprising:
an air guide having:
a plurality of air guide surfaces;
an air passage opening arranged between adjacent air guide surfaces;
a guide surface which extends from an air guide surface and corresponds to the air passage opening; and
an end region which extends from the guide surface in a plane which is substantially parallel to a plane of the surface of the air guide body,
wherein:
the guide surface begins at a first edge of the air passage opening and the end region ends at the opposite edge of the opening; and
the end region does not overlap with an adjacent surface that continues at the opposite edge of the air passage opening.

12. The motor vehicle of claim 11, wherein the air passage opening has a V-shaped cross-section.

13. The motor vehicle of claim 11, wherein the guide surface extends downwardly from a corresponding surface of the air guide body.

14. The motor vehicle of claim 12, wherein the air passage opening is configured to overlap the guide surface and the end region.

15. The motor vehicle of claim 13, wherein the air passage opening, the guide surface and the end region are arranged in a separate component configured for connection to the fan cowling.
